(19) United States
(12) Patent Application Publication
(10) Pub. No.: US 2010/0271587 A1
(43) Pub. Date: Oct. 28, 2010

(54) EYEWEAR COMPRISING AT LEAST ONE DISPLAY DEVICE

(76) Inventor: Panagiotis Pavlopoulos, Saint Jean De La Ruelle (FR)

Correspondence Address: O'Brien Jones, PLLC (w/Nony & Partners), 1951 Kidwell Drive, Suite 550 B, Tysons Corner, VA, 22182, US

(21) Appl. No.: 12/663,203

(22) PCT Filed: Jun. 7, 2007
(86) PCT No.: PCT/IB2007/001533

§ 371 Date: Jun. 29, 2010

(51) Int. Cl. G02C 11/00

(52) U.S. Cl. 351/158

(57) ABSTRACT

An eyewear comprising at least one region for receiving at least one vision lens, and at least one display device for displaying data to a person wearing the eyewear, the at least one display device comprising a display surface located in an upper portion of the at least one region.

The present invention relates to head mounted devices (HMD) comprising a display device.

Two types of head-up displays (HUD) are known:
fixed HUDs require the user to look through a display element attached to the airframe or vehicle chassis, the image of the real world depending solely on the orientation of the vehicle,
helmet-mounted or head-mounted HUDs (HMD) feature a securely-attached display element in front of the eye that moves with the orientation of the user's head.

A typical HMD has either one or two small display elements with lenses and semi-transparent mirrors embedded in a helmet, eye-glasses or visor.

In known devices, the displayed image is superimposed upon a real-world view by projecting the computer image through a partially reflective mirror or prism, the real world view being seen directly. To avoid refocusing of the user's eyes while reading a HMD, the display may be focused at infinity and optical techniques may be used to present the images at a distant focus, which in addition improve the realism of images that in the real world would be at a distance. Monocularly placed opaque or semi-transparent mirrors or prisms allow the image seen in one eye to be superimposed on the seeing part of the field of the other eye. A disadvantage of such devices obstructing fully or partially one eye may be the visual field loss, which may cause problems in mobility and navigation. Another disadvantage of such devices may be their rejection for everyday use by the wearers due to their negative esthetical aspect. Similar problems may also be encountered in solutions where for viewing the computer image an eye movement is required, excluding thus the simultaneous perception of the computer image and the real world by the same eye.

Eyewear including display devices are known for example from U.S. Pat. No. 6,349,001, WO 01 06298, U.S. Pat. No. 6,384,982 or EP 1544644.

EP 1544644 discloses a display device visible by a user when the latter moves the eye down. Such an eyewear is not appropriate for displaying hearing aid data as the user may need to see both the data displayed by the display device and the speaker in front of him, allowing thus lipreading and gestural communication support.

In U.S. Pat. No. 6,384,982 or U.S. Pat. No. 6,349,001 the data is displayed substantially in the middle of the lens, which may alter the vision of the user.

In WO 01 06298 the display device is situated in a lower region of the lens and the eyewear suffers similar drawbacks as in EP 1544664.

In order to avoid the drawbacks cited above, the possibility to place the projected image outside the vision axis of the eyes may be seen as particularly attractive since the direct visual field of both eyes perceiving the real world would remain completely unscreened. To achieve a superposition of the computer image and the image of the real world without any obstruction, optical devices might deflect the projected image from the periphery into the retina. HMD systems that project information through a low-powered laser directly onto the wearer's retina are in experimentation, but there is a need for HMD applications enabling to deflect the image into the retina through a passive optical system.

Several clinical techniques applied in the management of visual field loss following a cortical lesion from stroke, brain surgery or head trauma, may be classified as field expansion, which is actually the desired effect as it means that the simultaneously seen field is larger with the device than without it, including thus the off-centre computer image from the display element and the central vision of the image of the real world. These ophthalmologic techniques include utilization of field expansion devices such as mirrors, partially reflecting mirrors like beam spliters, reversed telescopes, a handheld minus lens, amorphous lenses, and Fresnel prisms. The medical indication of such optical devices, deflecting images from the defected into the healthy region of the retina, is also important in other ophthalmopathies, as in bothersome diplopia, in Graves' patients¹, in strabismus and in fourth and sixth nerve paresis², where stick-on Fresnel prisms³ allow the elimination of primary position diplopia. (InterRyc volume 4, 2001—JKA Institute of Strabismology and binocular Vision; 2701 Rain Tree Court, Columbia, Mo. 65201, USA; www.geocities.com/sapatneyl)

(<<Diagnosis and Treatment of Strabismus in Seniors>>; M. L. Silversberg, MD, and E. Schuler, CO; Edited by D. R. Stager Sr., I. U. Scott and S. Fekfrat; American Academy of Ophthalmology http://www.aao.org/plubications/eyenet/200605/pearls.cfm)
(Conventional prisms allow clearer vision, whereas Fresnel prisms though lighter and thinner, usually become yellowish after some time.)

These devices have limited success in clinical practice which may be explained by the insufficient consideration of the dynamic nature of eye and head movements of the patients. The limitations may be even more severe in using them in HMD systems, where compensation by head and eye movements or changes of fixation is not applicable.

There is a need for improved eyewear that may allow a simultaneous view o f the computer image and the real world by the same eye.

Exemplary embodiments of the present invention provide an eyewear comprising:
at least one region for receiving at least one lens, and
at least one display device for displaying data to a person wearing the eyewear, the at least one display device comprising a display surface located in an upper portion of the at least one region.

The invention may facilitate the seeing of the displayed data for people that need to maintain an ability of close vision as well as distance vision, as is the case for example for people wearing progressive lenses.

The display surface may not occlude in the present invention the visual field of the user.

The displayed data may be hearing aid data but the present invention is not limited to a particular kind of data being displayed and the displayed data may comprise data in any consumer and industrial applications such as surgery, educative activities, viewing movies, playing games, avionics or military activities and “informative eyewear”.

The eyewear may comprise:
at least one region for receiving at least one vision lens, and
at least one vision lens in the at least one region.

The at least one vision lens may be a progressive lens and the display surface may be configured to be viewed by the person wearing the eyewear through the distance section of the progressive lens.

The eyewear may comprise at least one rim portion that defines at least in part the upper border of the at least one region, and the display device may extend at least in part above the rim or be integrated within.

The display device may comprise an imaging device and the display device may comprise optical components defining an optical path between the imaging device and the display surface.

The optical components may be configured to ensure the image from the imaging device to be presented to a user at a distant focus.

The optical components may constitute at least a monocular deflector configured to shift the image from the imaging device by 15 to 20° relative to the eye axis of the person wearing the eyewear.

At least a fraction of the optical components may be placed base-out at the upper part of the vision lens, which may enable the upper quadrant of the visual field at all portions of gaze to be expanded. The optical components may be configured to deviate the image from the periphery into the retina, which is limited to the superior peripheral visual field area corresponding to the distant vision in multifocal lenses.

The display device may be placed across the whole width of the region, centred and spanning both sides of the pupil so that it is effective at all lateral positions of gaze. The display device may enable the visual field to be expanded via peripheral diplopia being much more comfortable for the user than central diplopia, since peripheral diplopia is a common feature of normal vision.

This field expansion effect provided by the optical components may be unaltered by eye and head movements over a wide range of such movements into either side.

In an exemplary embodiment, the optical components may comprise at least one prism defining at least partially the optical path and configured to refract the luminous rays.

The at least one prism may be a high power of 30 to 40 dioptres (D) prism placed across the centre of the vision lens above the pupil at about the level of the limbus.

The at least one prism may comprise a reflective layer and the reflective layer may define at least partially the optical path.

The optical components may comprise a first prism and a second prism and a first lens and a second lens. The first and second prisms and the first and second lenses may define at least partially the optical path.

Each lens may have a convex side, and the convex side of the first lens may face the convex side of the second lens.

The first lens may define a secondary focal point and the second lens may define a primary focal point. The secondary focal point of the first lens may coincide substantially with the primary focal point of the second lens.

In another exemplary embodiment, the optical components may comprise at least one reflecting surface defining at least partially the optical path.

The optical components may comprise two reflective surfaces defining at least partially the optical path.

The optical components may comprise a single lens between the two reflective surfaces. The lens may have a primary focal point that coincides with the imaging device. The lens may have a spherical incident face and an aspherical outlet face.

The optical components may comprise two quasi-perpendicular polarizers that may enable to improve the resolution, diminish blur and achromaticity, and adjust partially the light intensity.

In another exemplary embodiment, the optical components may comprise at least one prism and at least one reflective surface.

The display device may comprise a housing accommodating at least one of the optical components defining the optical path and mentioned above.

The reflective surfaces may comprise metal layers deposited on internal surfaces of a body of the housing or totally reflecting elements.

At least one of the reflective surfaces may be constituted by a mirror fitted to the body of the housing.

The optical path may comprise an intermediate portion extending substantially perpendicular to a major axis of the eyewear.

The display device may comprise an optical element that defines the display surface. This optical element may comprise a prism or a reflective surface.

The display surface may be configured to enable a setting with respect to the vision lens of the eyewear of a direction of light from the display surface relative to the eye axis of the person wearing the eyewear. The optical element defining the display surface may be hinged on a body of the housing of the display device.

Such an arrangement may enable the display surface to be orientable relative to the vision lens.

The imaging device may comprise an organic light emitting diode (OLED) matrix display.

The imaging device may comprise a color filter active matrix liquid crystal display and a light emitting diode backlight.

The imaging device may be of a resolution greater or equal to VGA resolution, for example extending up to 1280×1024 pixels.

The display device may be configured thanks to a software treatment to display with the imaging device a reverse or mirrored image of the data to be displayed on the display surface. “Reverse or mirrored image” means an image inverted right to left and projected into the opposite direction compared to what it really is.

The display device may be integrated within the eyewear.

The eyewear may include an electronic circuit comprising an input interface for receiving data to be displayed.

The input interface may comprise a wireless interface.

The input interface may comprise at least one of a memory chip and cord connector.

The display device may be removably fixed to the eyeglass frame.

Exemplary embodiments of the present invention provide a method for displaying data to a person wearing an eyewear comprising at least one vision lens, the method comprising displaying data in an upper region of at least one vision lens using a display device.

The vision lens may be a progressive lens and the upper region may be a distance section of the progressive lens.

The data being displayed may be hearing aid data.

It is to be understood that both the foregoing general description and the following detailed description are exemplary and explanatory only and are not restrictive of the invention.

The accompanying drawings, which are incorporated in and constitute a part of this specification, illustrate several exemplary embodiments of the invention and together with the description, serve to explain principles of the invention.

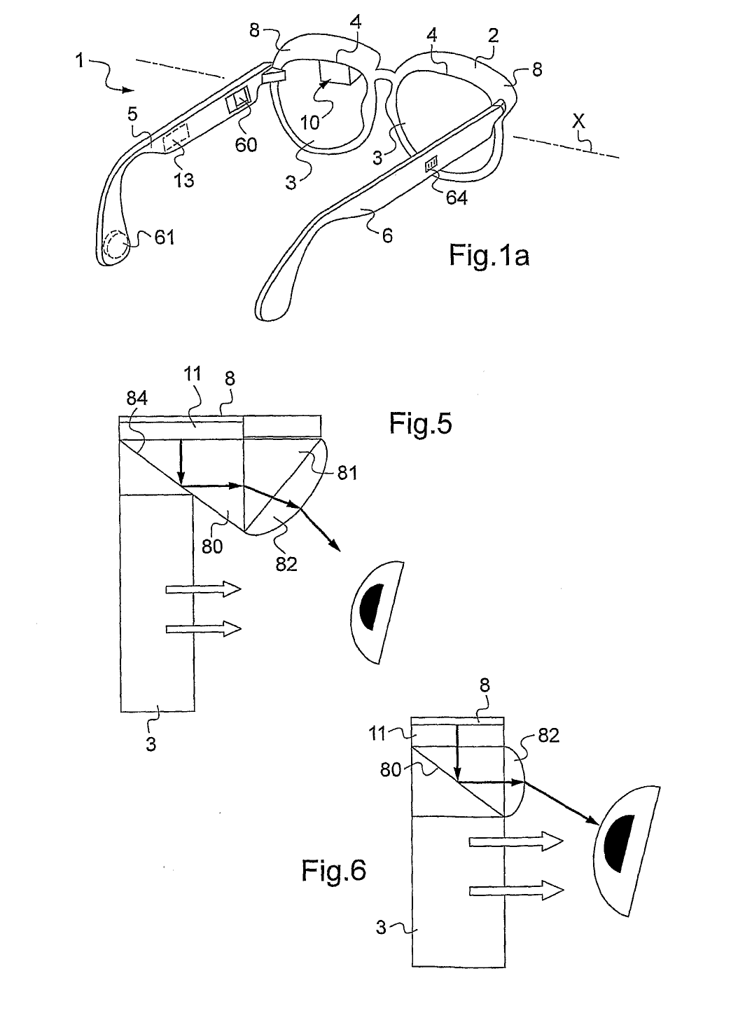

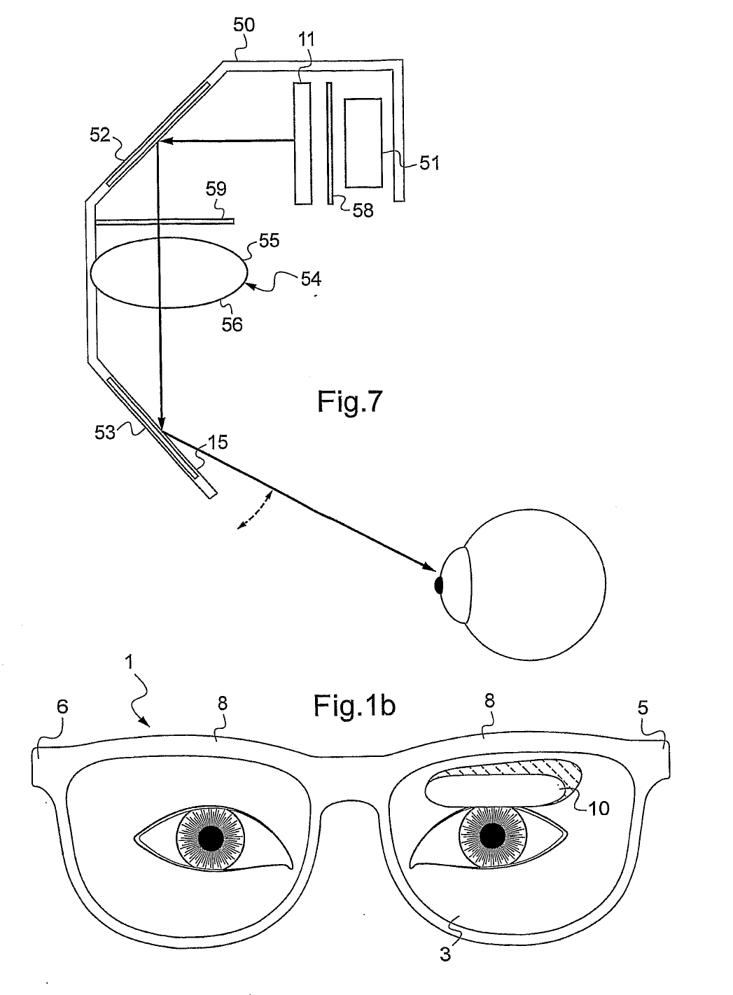

FIG. 1a is a perspective view of an exemplary embodiment of eyewear made in accordance with the present invention,

FIG. 1b is a front view of the embodiment of FIG. 1a,

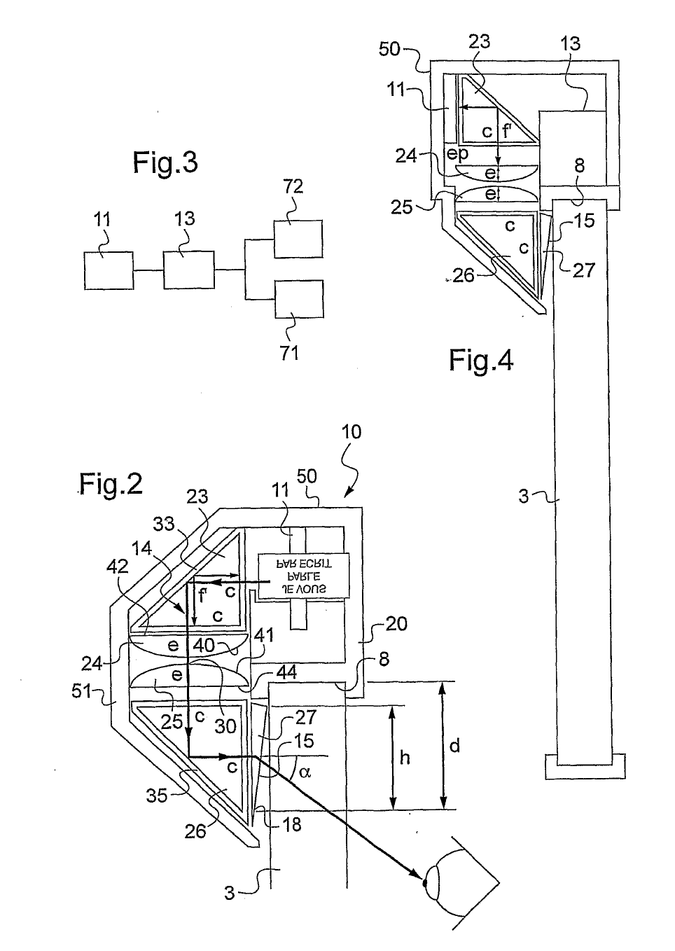

FIG. 2 is a schematic view of a display device according to an exemplary embodiment comprising prisms of the present invention,

FIG. 3 is a schematic diagram of an exemplary embodiment of components involved in the transmission of data to the eyewear,

FIGS. 4 to 6 are views similar to FIG. 2 of other exemplary embodiments of the present invention, and

FIG. 7 is a view similar to FIG. 2 of another exemplary embodiment of the present invention comprising mirrors.

FIGS. 1a and 1b depict an eyewear 1 comprising an eyeglass frame with two rims 8 defining regions 4 for supporting two corresponding vision lenses 3. Each region 4 is defined by the aperture of a rim 8.

The eyewear 1 comprises left and right temples 5 and 6 which may for example be hinged on the rims 8.

One rim 8 supports in the illustrated embodiment a display device 10 which will be described with more details with reference to FIG. 2.

The display device 10 comprises an imaging device 11 which may comprise an imaging matrix such as an organic light-emitting diode matrix display or a liquid crystal display.

Organic light-emitting diode matrix (OLED) display may be also selected amongst PHOLED (phosphorescent OLED), TOLED (transparent OLED) or FOLED (flexible OLED), inter alia.

An example of color filter active matrix liquid crystal display with diagonal dimension of 0.16 inches is available from the US company KOPIN Corporation under the tradename CyberDisplay™ and exhibits a spatial resolution of 521×218 dots. Such a liquid crystal display may be back lit by a backlight (not shown in FIG. 2).

The imaging device 11 may receive video signals such as parallel RGB analog signals for example from an electronic circuit 13 shown schematically on FIG. 3 and which may be carried all or part by the eyewear.

The imaging device 11 emits luminous rays which follow an optical path 14 to reach a display surface 15 situated in the upper region of the aperture 4.

The display device 10 may be placed across the upper region of the vision lens 3, and thus affect the user in all positions of gaze. The peripheral location of the display device 10 may provide a peripherally diplopic field as wide as the field of the display device and shifted by 15 to 20 degrees relative to the eye axis, providing thus a real field expansion of 15 to 20 or more degrees over the height of the display device.

The display surface 15 may extend over a height h that ranges for example from 3 mm to 5 mm.

The lower end 18 of the display surface 15 may be distant from an upper edge 20 of the lens 3 by a distance ranging for example from 5 mm to 13 mm.

The display surface 15 may extend within the upper third or even the upper quarter of the total height of the lens 3. The total height of the lens 3 may range for example from 20 mm to 50 mm, being for example equal to about 40 mm.

The optical path 14 may be defined successively by a first prism 23, a first lens 24, a second lens 25 and a second 26 and third 27 prisms, as shown in FIG. 2.

The optical path 14 may comprise an intermediate portion 30 which extends downward between the first 23 and second 26 prisms substantially perpendicularly to a major axis X of the eyewear.

The first prism 23 may deviate the luminous rays emitted by the imaging device 11 at a right angle, thanks to reflection or even total reflexion on an oblique reflective surface 33.

The second prism 26 may reflect the incident luminous rays after crossing the first and second lenses at a right angle also, thanks to an oblique reflective surface 35.

The third prism 27 defines the display surface 15 and may deviate the incident luminous rays downward by an angle a which may range from 15° to 25°.

At least one of the first prism 23, the second prism 26 and the third prism 27 may be a high power of 30 to 40 dioptres (D) prism placed across the centre of the vision lens above the pupil at about the level of the limbus.

The first lens 24 has a secondary focal point that is substantially coinciding with the primary focal point of the second lens 25 so that the luminous rays are collimated at the infinity after crossing the second lens 25.

The first lens 24 may have a convex surface 40 which is facing a convex surface 41 of the second lens 25. The convex faces 40 and 41 may be spherical.

The first lens 24 may have an incident face 42 which may be planar and may extend substantially parallel to an output adjacent face of the first prism 23.

The second lens 25 may have an outlet face 44 which may be planar and substantially parallel to an adjacent input face of the second prism 26.

The reflective surfaces 33 and 35 may be metallised, for example aluminium or silver coated, in order to improve the reflection. In a variant, the reflective surfaces are created only by a difference of refraction indices between the material of the prism and the optical medium outside the prism.

The optical components defining the optical path 14 may be made with glass or plastics materials of high refraction index such as polycarbonate, for example.

In the example shown in FIG. 2, the lenses 24 and 25 are separate from the prisms 23 and 26 but in other non shown embodiments the lenses may contact the prisms or may be made integrally with them and possibly integrated in the rim of the eyewear.

For example, the lens 24 may be made monolithically with the prism 23 and the lens 25 may be made monolithically with the prism 26. In another variant not shown, the prisms 23 and 26 and the lenses 24 and 25 are all made monolithically by molding plastics material possibly within the rim of the eyewear.

The video signals sent to the imaging device 11 may be processed so that the image displayed by the imaging device 11 is a reverse or mirrored image of the image displayed on the display surface 15.

The electronic circuit 13 supplying the imaging device 11 with the video signals may comprise a video processor which is configured to generate such a reverse image. In a variant, the electronic circuit 13 receives video data already processed for displaying a reverse image.

The electronic circuit 13 may comprise various components necessary to process the data received from outside the eyewear, for example via a wireless interface 71 or a cord or a memory chip connector 72.

The wireless interface 71 may be a radio interface such as for example a BLUETOOTH or WIFI interface or an infrared interface, depending on the application in relation to the amount of data to be transferred.

The data may be supplied to the eyewear by a base station (not shown) worn by the user or lying near the user.

In a variant, the eyewear is autonomous and generates its own data to be displayed. For example, the eyewear comprises a microphone and a processor to generate hearing aid data based on audio signals received from the microphone. In another variant, the eyewear includes a positioning data from satellites and the data displayed aims at guiding the user to follow a route or reach a destination.

The cord or memory chip connector 72 may comprise a USB Ethernet or RS 232 input or a slot for a memory chip such as for example a SD card format.

The electronic circuit 13 may comprise any component for processing the input data and generate the video signals for the imaging device 11.

The electronic circuit 13 may comprise for example a driver circuit for the imaging device 11 such as for example the component KCD A210 BA available from the company KOPIN.

The electronic circuit 13 may also comprise a component to manage the incoming data and the memory screen, such as for example the one available under reference FPGA EP 2C5F256C7 from the company ALTERA.

The data sent to the eyewear may be in compressed format, for example JPEG 2000 and electronic circuit 13 may comprise a digital signal processor to decompress the data and generate for example video signals under the format BT 656 readable by the driver KCD A210 BA mentioned above. In the embodiment depicted in FIG. 1a, the electronic circuit 13 comprises at least some components that are housed in at least one of the temples. These components may comprise, for example, an ON/OFF switch 60 and a battery 61 to provide energy to both the electronic circuit 13 and the imaging device 11. Both temples may house a battery, although not shown.

A temple may also support a connector 64 for connecting the eyewear to an electrical source for recharging the battery.

The electronic circuit 13 may also comprise a buffer memory to improve fluidity of the images displayed, a voltage converter and a regulator for charging the imaging device 11.

The vision lens 3 may be any kind of vision lenses and may be a vision correcting lens, for example for a presbyopic correction.

In exemplary embodiments, the vision lenses are progressive lenses comprising a distance region extending in the upper part of the vision lens and a close region extending in the lower part of the vision lens.

The display surface 15 is extending behind the distance region so that the user correctly sees the data displayed on the display surface and collimated at the infinity.

The display device 10 may comprise as shown in FIG. 2 a housing 50 which may comprise a front portion 51 extending on the front side of the rim 8 for receiving the various optical components defining the optical path 14.

The housing 50 may comprise a body made by moulding plastics material and the housing 50 may be fitted to the adjacent rim 8 or may be made at least partially monolithically with the rim 8.

The components of electronic circuit 13 may be located at least partially within the housing 50, for example above the rim 8.

In the example depicted in FIG. 2, the imaging device is located within the housing 50 above the lens and projects the corresponding luminous rays forward.

In the variant depicted in FIG. 4, the imaging device 11 is located in the front portion of the housing 50 and the prism 23 is inverted compared to FIG. 2.

In the variant depicted in FIG. 5, the display device comprises a first prism 80, a second prism 81 and an eyelens 82.

The prism 80 comprises a semi-reflective surface 84 which allows ambient imagery to mix with luminous rays emitted by the imaging device 11.

The prism 81 deviates downward the luminous rays coming from the prism 80 and the eyelens 82 has a vergence adapted to the vision of the person wearing the eyewear and defines the display surface.

The variant of FIG. 6 differs from the one of FIG. 5 by the absence of the prism 81.

In the variant depicted in FIG. 7, the display device 10 includes two polarizers 58 and 59, a single lens 54 and is devoid of any prism.

In the depicted embodiment, the polarizers 58 and 59 are linear polarizers.

The reflection in the optical path 14 is provided by the inner surface of the housing 50 that includes a first 52 and a second 53 reflective surface.

In the depicted embodiment, the housing 50 comprises a body made of polycarbonate and the reflective surfaces 52 and 53 are metal layers of the metal deposited on internal surfaces of the body. The metal may be vacuum deposited.

The first linear polarizer 58 may be placed between a back light 51 and the imaging device 11.

The second linear polarizer 59 may be placed between the first 52 and second 53 reflective surfaces.

These linear polarizers may improve resolution, diminish blur and achromaticity, and help adjust light intensity.

The lens 54 may be configured to simulate the distant vision and may be placed between the second linear polarizer 59 and the second reflective surface 53. This lens 54 may have a spherical incident face 55 and an aspherical outlet face 56 and may provide the user with a virtual image corresponding to a screen of 18 inches at a distance of 1.5 m with a visual field of 17° for example.

As shown in FIG. 7, the second reflective surface 53, which defines the display surface 15 may be hinged on a portion of the body of the housing 50, to enable a setting of the direction of reflection of the luminous rays coming from the other optical components defining the optical path. This setting may be made for example at the moment where the vision lens is fitted to the frame or when the eyewear is first tried by the person wearing the eyewear.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. The characteristics of the various embodiments of the invention as described above may be combined with one another in variants not shown.

In a variant, the optical components defining the optical path may comprise a Fresnel press-on prism segment, which may enable to cut down on manufacturing costs.

Furthermore, the eyeglass frame may have different shapes and may be held differently on the head of a user.

Throughout the description, including in the claims, the terms “including a” or “comprising a” should be understood as being synonymous with “including at least one” unless specified to the contrary.

1.-34. (canceled)

35. An eyewear comprising:
at least one region for receiving at least one vision lens, and
at least one display device for displaying data to a person wearing the eyewear, the at least one display device comprising a display surface located in an upper portion of the at least one region.

36. The eyewear according to claim 35, comprising the at least one vision lens in the at least one region.

37. The eyewear according to claim 36, wherein the at least one vision lens is a progressive lens.

38. The eyewear according to claim 37, wherein the display surface is configured to be viewed by the person wearing the eyewear through the distance section of the progressive lens.

39. The eyewear according to claim 35, comprising at least one rim portion that defines at least in part the upper border of the at least one region, wherein the display device extends at least in part above the rim.

40. The eyewear according to claim 35, comprising at least one rim portion that defines at least in part the upper border of the at least one region, wherein the display device is integrated within the rim portion.

41. The eyewear according to claim 35, wherein the display device comprises an imaging device and wherein the display device comprises optical components defining an optical path between the imaging device and the display surface.

42. The eyewear according to claim 41, wherein the optical components are configured to shift the image from the imaging device by 355 to 20° relative to the eye axis of the person wearing the eyewear.

43. The eyewear according to claim 41, wherein the optical components comprise at least one prism defining at least partially the optical path.

44. The eyewear according to claim 43, wherein the at least one prism is a high power of 30 to 40 dioptres prism placed across the center of the region.

45. The eyewear according to claim 43, wherein the at least one prism comprises a reflective layer and wherein the reflective layer defines at least partially the optical path.

46. The eyewear according to claim 43, wherein the optical components comprise a first prism and a second prism and a first lens and a second lens, and wherein the first and second prisms and the first and second lenses define at least partially the optical path.

47. The eyewear according to claim 46, wherein each lens has a convex side, wherein the convex side of the first lens faces the convex side of the second lens.

48. The eyewear according to claim 46, wherein the first lens defines a secondary focal point and the second lens defines a primary focal point and wherein the secondary focal point of the first lens coincides substantially with the primary focal point of the second lens.

49. The eyewear according to claim 35, wherein the optical components comprise two reflective surfaces defining at least partially the optical path.

50. The eyewear according to claim 49, wherein the optical components comprise a single lens having a spherical incident face and an aspherical outlet face.

51. The eyewear according to claim 49, wherein the optical components include two polarizers that define at least partially the optical path.

52. The eyewear according to claim 40, wherein the display device comprises a housing that accommodates at least one optical component defining the optical path.

53. The eyewear according to claim 40, wherein the optical path comprises an intermediate portion extending substantially perpendicular to a major axis of the eyewear.

54. The eyewear according to claim 35, wherein the display device comprises a prism that defines the display surface.

55. The eyewear according to claim 35, wherein the display device comprises a reflective surface that defines the display surface.

56. The eyewear according to claim 55, wherein the display surface is configured to enable a setting of a direction of light from the display surface towards the person wearing the eyewear.

57. The eyewear according to claim 52, wherein the display surface is hinged on a body of the housing of the display device.

58. The eyewear according to claim 35, wherein the imaging device comprises an organic light emitting diode (OLED) matrix display.

59. The eyewear according to claim 35, wherein the imaging device comprises a color filter active matrix liquid crystal display and a light emitting diode backlight.

60. The eyewear according to claim 35, wherein the imaging device is of a resolution greater or equal to VGA resolution.

61. The eyewear according to claim 35, wherein the display device is configured to display with the imaging device a reverse image of the data to be displayed on the display surface.

62. The eyewear according to claim 35, wherein the eyewear includes an electronic circuit comprising an input interface for receiving data to be displayed.

63. The eyewear according to claim 62, wherein the input interface comprises a wireless interface.

64. The eyewear according to claim 62, wherein the input interface comprises at least one of a memory chip and cord connector.

65. The eyewear according to claim 35, wherein the display device is removably fixed to the eyeglass frame.

66. A method for displaying data to a person wearing an eyewear comprising at least one vision lens, the method comprising displaying data in an upper region of at least one vision lens using a display device.

67. The method according to claim 66, wherein the vision lens is a progressive lens and wherein the upper region is a distance section of the progressive lens.

68. The method according to claim 66, wherein the data being displayed is hearing aid data.
